(19) United States
(12) Patent Application Publication
(10) Pub. No.: US 2014/0032437 A1
(43) Pub. Date: Jan. 30, 2014

(54) TRAVEL APP

(71) Applicant: Eric Steven Greenberg, New York, NY (US)

(72) Inventor: Eric Steven Greenberg, New York, NY (US)

(21) Appl. No.: 13/942,705

(22) Filed: Jul. 16, 2013

Related U.S. Application Data
(60) Provisional application No. 61/676,118, filed on Jul. 26, 2012.

(51) Int. Cl. G06Q 50/20; G06Q 10/00

(52) U.S. Cl. CPC G06Q 50/205; G06Q 10/00
USPC 705/327

(57) ABSTRACT

A system and method to conduct a search for visits of colleges and/or universities (C/Us) comprising the steps of: entering student data into an input device; entering locating information and a desired radius limitation into the input device; and generating C/Us relevant to the student data and within the radius limitation. Another embodiment comprises the steps of: sending locating information and a desired radius limitation to an input device; generating C/Us within the radius limitation; selecting C/Us of interest; and generating information about selected C/Us. Another embodiment relates to a system and method to conduct a search visit of destinations comprising the steps of: entering destination data into an input device; entering locating information and a desired radius limitation into the input device; and generating destinations relevant to the destination data and within the radius limitation.

“This application claims the benefit under 35 U.S.C. 119 (e) of any U.S. provisional application(s) listed below.

Application No. 61/676,118, having a filing date of Jul. 26, 2012.”

### FIELD OF THE INVENTION

The present invention relates to a system and a method for visiting, searching for, or choosing from a variety of destinations, generally, and, more specifically, Colleges and Universities (“C/Us”), and planning an itinerary and providing directions for visiting the same, including obtaining relevant information about the destinations, as well as, local restaurants, lodging and gas information, and relevant information about nearby destinations to add to the itinerary if time permits, all of which make travelling more economical, more useful and more convenient.

### BACKGROUND OF THE INVENTION

The present invention was made to fill a gap in visiting/searching for and choosing from destinations, generally, and, more specifically, Colleges and Universities (“C/Us”).

Geography is an important factor when deciding on C/Us since it has been shown that (an estimated) 75% of college students go to schools within (approximately) 230 miles of their homes (Journal of College Admission). However, no prior art was found that specifically discloses a specialized College/University (“C/U”) visitation program to aid in locating relevant nearby C/Us or which concerns a visitation trip where a goal is a pre-attendance C/U trip.

The state of the prior art does not deal specifically with pre-attendance C/U planning, the prior art does not live feed curriculum/course information or allow the input of student specific information (e.g., qualifying SAT/GPAs) and/or C/U specific information (e.g., student population, average tuition costs, etc.) to help choose appropriate and relevant nearby C/Us.

Most college research tools cover so many bases that they either don't address the college visit in depth at all or they spend time addressing what goes on after the student is enrolled in school.

The present invention addresses these issues by allowing for a search for relevant C/Us over a certain size area over the radius you choose, and providing relevant information about each school, along with details such as size, cost, tours, info sessions, their website, contact info., etc. This invention saves time by maximizing efficiency and saves money by minimizing travel costs while also presenting options and choices that might have been missed without this app.

### SUMMARY OF THE INVENTION

The present invention relates to a system and a method for visiting, searching for, or choosing from a variety of destinations, generally, and more specifically, Colleges and Universities (C/Us), using radius searching. It can combine primary target or primary desired and secondary nearby destinations as well as data input of different types to narrow search results. More relevant search results are also obtained by searching within a desired radius of a primary target or primary desired location, secondary nearby destinations, or other destination.

The search results can be provided in the form of an itinerary together with directions for visiting the destinations. They can also include relevant information about the destinations, as well as information about local restaurants, lodging, gas stations, and other possible stops or sites along the way.

The system and method of the invention also makes possible two-way communication between the user and the destination to allow the user to make appointments (e.g., schedule interviews), reservations (e.g., for dinner), etc. The system and method of the invention can be included in the form of a mobile app to make it easier to make such appointments and reservations on the go and to obtain relevant information about nearby destinations to add to the itinerary if time permits, all of which make travelling more economical, more useful and more convenient.

The system and method of the invention lets a user find destinations within a chosen radius to make visits, including travel directions/options, local restaurants, hotels, gas stations, etc. pertaining to the trip itineraries. The present invention fills a niche that no other App fully explores.

When using the system and method of the invention, a search for relevant C/Us over a certain size area over a radius you choose, provides relevant information about each school, along with details such as size, cost, tours, info sessions, their website, contact info., etc.

This invention saves time by maximizing efficiency and saves money by minimizing travel costs.

### BRIEF DESCRIPTION OF THE DRAWINGS

FIG. 1 is a schematic view of an example of the operation of the system and the method for searching for or choosing from destinations;

FIG. 2 is a schematic view of an example of the operation of another embodiment of the system and the method for searching for or choosing from destinations;

FIG. 3 depicts a smartphone with a Nearby Colleges Icon. Submitter clicks the mobile application icon to startup/initiate the mobile application;

FIG. 4 depicts an example of the flow of creating a new search request;

FIG. 5 depicts an illustrated block diagram of an exemplary information handling system;

FIG. 6 depicts an example of a typical system enabling bi-directional connection;

FIG. 7 depicts a search screen;

FIG. 8 depicts an example of a results screen;

FIG. 9 depicts an example of a results screen;

FIG. 10 depicts an example of a results screen;

FIG. 11 depicts an example of a results screen; and

FIG. 12 depicts an example of a results screen.

### DETAILED DESCRIPTION OF THE INVENTION

The following description is intended to facilitate the understanding of the present invention without limiting its scope:

### Definitions

Destination—At least one of: a place, structure, event, site, address, school, tourist site, college, university, business, desired location, target location, nearby location, additional location, location, movie theatre, store, office, facility, professional space, professional location, professional address, professional office, professional practice, specialty store, gas, restaurant, food, lodging, hotel, hostel, camp site, and/or medical, dental, and/or health related practices, etc.

Destination Data—At least one of: geographic coordinate(s), geolocation, longitude and/or latitude, measurements, address in part or in whole, a place, structure, event, site, address, school, tourist site, college, university, desired location, business, target location, nearby location, additional location, location, movie theatre, store, office, facility, professional space, professional location, professional address, professional office, professional practice, specialty store, gas, restaurant, food, lodging, hotel, hostel, camp site, and/or medical, dental, and/or health related practices, etc.

Stops—are places, destinations, or locations of interest and/or to include in your travel plans or trip.

locating information—is at least one of longitude, latitude, location coordinates, a city, zip code, street address, street name, state, nearby location, county, village, town, landmark, destination, college, university, school name, phone number in part or in whole, email, web address, social media address, and/or Skype name, information that helps to determine the starting or beginning point of a search, and/or information that helps to determine any point or destination of a search, etc.

Input device—tablets, smart phones, phone, mobile device, smart device, computers, voice prompt, microphone, fax, facsimile, electronic device, iphone, ipad, Bluetooth device, hand held device, iphone, ipad, mobile phone, touch-screen computing device, portable media player, smart pad, micro device, portable device, powered device, technical device, electronic component device, ios device, virtual device, virtual input device, global positioning system (GPS), optical device, optical reader, any information or data input communication device, the means by which a user can communicate with the system and method of the invention, touch pad, or tablet to provide an activated application and open a log-in screen. etc.

User Interface—the means by which a user can communicate with the system and method of the invention, e.g., a computer, fax, voice prompt, key board, touch pad, phone, mobile device and/or smart device, Input device, tablets, smart phones, phone, mobile device, smart device, computers, voice prompt, microphone, fax, facsimile, electronic device, iphone, ipad, Bluetooth device, hand held device, iphone, ipad, mobile phone, touch-screen computing device, portable media player, smart pad, micro device, portable device, powered device, technical device, electronic component device, ios device, virtual device, virtual input device, global positioning system (GPS), optical device, optical reader, and/or any information or data input communication device, or tablet to provide an activated application and open a log-in screen. etc.

Smart device—A smart device is an electronic device that is usually cordless (unless while being charged), usually mobile (easily transportable), usually connected or connectable to the virtual or internet (via WiFi, 3G, 4G etc.), and is capable of voice and video communication, internet browsing, geolocation (for search purposes and location-based services) and that can usually operate to some extent autonomously. Several notable devices at time of writing are smartphones iPhone, Ipad, and tablets, like the Apple iPad. The term can also refer to a ubiquitous computing device: a device that exhibits some properties of ubiquitous computing including artificial intelligence. Smart devices can be designed to support a variety of form factors and a range of properties pertaining to ubiquitous computing and also be used in any combination of three main system environments: physical world, human-centred environments and distributed computing environments.

Internet—generically/commonly known internet networks, virtual networks, communication highway, communication conduit, world wide web, wide area networks (WAN), and/or local area networks (LAN).

LAN—local area networks (LAN).

Social Network—a private and/or public website or network that enables the connection of any number of users for any number of purposes.

Virtual—occurring, relating to, or existing within a virtual reality or for all practical purposes an existence which is possible or inferred.

WAN—wide area networks (WAN).

According to one embodiment, the invention is a system and a method to conduct a search to visit colleges and/or universities (C/Us) comprising the steps of: entering student data into an input device; entering locating information and a desired radius limitation into a input device; and generating C/Us relevant to the student data and within the radius limitation.

Additionally, the system and method of the invention can have a software element that can communicate with a map API (application programming interface) to provide directions and/or a map. The map API can be sourced from a third party if desired. Information on public or other transportation (including but not limited to train, plan, boat, and/or ground transportation information) can be obtained from the internet and provided in addition to or instead of the directions and/or map.

The student data may be one or more student qualifications and/or student choices. Examples of student qualifications include, but are not limited to, SAT scores, GPA scores, high school attended, etc. Examples of student choices include, but are not limited to, school size, number of students, average tuition, curriculum/courses, degrees offered, etc.

The input device is where the user enters information for the system and method of the invention to use. Examples include, but are not limited to, tablets, smart phones, phone, mobile device, smart device, computers, voice prompt, microphone, fax, facsimile, electronic device, iphone, ipad, Bluetooth device, hand held device, iphone, ipad, mobile phone, touch-screen computing device, portable media player, smart pad, micro device, portable device, powered device, technical device, electronic component device, ios device, optical device, optical reader, global positioning system (GPS), etc. The locating information provides the system and method of the invention with a geographic point from which to do a search. Examples include, but are not limited to, a longitude, latitude, location coordinates, city, zip code, street address, street name, state, nearby location, county, village, town, landmark, destination, college, university, school name, phone number in part or in whole, email, web address, social media address, Skype name, Destinations, a place, structure, event, site, address, school, tourist site, college, university, business, desired location, target location, nearby location, additional location, location, movie theatre, store, office, facility, professional space, professional location, professional office, professional practices, professional address, specialty store, gas, restaurant, food, lodging, hotel, hostel, camp site, and/or medical, dental, and/or health related practices, etc. A landmark might also be considered a destination, e.g., Grand Central Terminal would qualify under either definition. Examples of other landmarks include, but are not limited to, the Washington Monument, the Empire State Building, a specific Frank Lloyd Wright house, etc. Examples of other destinations include, but are not limited to, airports, zoos, parks, beaches, foreign countries, etc.

A desired radius limitation can be used and it can be in a specific unit(s) of measurement, including, but not limited to, feet, yards, miles, meters, etc. Also, any amount can be entered as the desired radius limitation, including, but not limited to, 1 mile, 5 miles, 10 miles, 15 miles, 20 miles, 30 miles, 40 miles, 50 miles, 75 miles, 100 miles, 150 miles, etc.

Based on the student data and desired radius limitation that have been entered into the input device, the system and method of the invention generates relevant C/Us. That is, the C/Us generated would meet or approximate the student qualifications and/or student choices entered as well as the desired radius limitations.

The user can select one or more of the C/Us from the relevant C/Us that are generated. Then, the system and method of the invention can generate information about the selected C/Us. Examples of such information about the C/Us can include, but is not limited to, student population, average annual tuition, tour availability, information sessions, etc. The information generated about the selected C/Us can be in the form of links, for example, but not limited to, a link to call the C/Us, link to the C/Us' website, link to the C/Us' facebook page, etc. Still another type of link would be a link to make an online appointment for an interview at the C/Us.

The system and method of the invention can provide an itinerary of the selected C/Us including directions and available public transportation to the selected C/Us. The directions provided with the itinerary can be in any useful format, for example, but not limited to, turn-by-turn, voice, map, etc.

The itinerary can include other stops (additional destinations) besides C/Us. For example, the user might be interested in finding a store or restaurant for some food, a place to stay overnight, a gas station, a library, a post office, etc. The system and method of the invention can generate such other stops automatically when it generates the C/Us. Also, it can generate specific other stops by the steps of:

entering other stops data into the input device;

entering the C/Us or other locating information and a desired radius limitation into the input device; and

generating other stops relevant to the other stops data and within the radius limitation.

The other stops data is information about the desired stop. Such information includes, but is not limited to, a type of store, restaurant, the name of a specific restaurant or restaurant chain, a place to stay overnight, the name of a specific hotel or hotel chain, a gas station, the name of a specific gas station or chain of gas stations, a library, a post office, etc.

One feature of the system and method of the invention is that it is easy to find other C/Us near the originally selected C/Us. There are several ways of doing this. The original search will, of course, include any C/Us near the originally selected C/Us. Another way is to run the original search again. Input the same student data, the same or similar locating information (any one of the selected C/Us or associated data can be used as the locating information), and the same, or similar, or even a different radius limitation. The system and method of the invention will then generate relevant C/Us (relevant to the student data, locating information and radius limitation). Other or additional C/Us can be found at the start of the trip or during the trip if, for example, the user finds that there is more time to visit more C/Us. Another way to find nearby C/Us is by entering into the input device a second locating information, which can be the same or different from the first, and a second desired radius limitation, which can be the same or different from the first. This will generate a second batch of C/Us relevant to the student data and within the second radius limitation. The user can then select C/Us from the second batch of C/Us. The system and method of the invention can then provide an itinerary, including directions/available public transportation, based on the first batch and the second batch of the selected C/Us.

In addition to the above-described methods of finding other C/Us near the originally selected C/Us, the system and method of the invention can find nearby C/Us by repeating a search of C/Us within a radius limitation of one or more of the selected C/Us; generating repeat C/Us within the radius limitation of one or more of the selected C/Us; selecting repeat C/Us of interest; and generating information about the selected C/Us of interest.

Another embodiment of the invention does not need student data to be input. Instead, just locating information and a desired radius limitation are input or sent to an input device. The system and method of the invention can then generate C/Us within the radius limitation. The user can select C/Us of interest and then the system and method of the invention can generate information about the selected C/Us. In this embodiment, it is possible for the system and method of the invention to generate all C/Us within the radius limitation. It is also possible to generate an itinerary with directions. The locating information, desired radius limitation and type of input device can be the same or different as in the other embodiments.

In yet another embodiment, the system and method of the invention conducts a search of destinations to visit comprising the steps of:
entering destination data into an input device;
entering locating information and/or a desired radius limitation into the input device; and
generating destinations relevant to the destination data and/or within the radius limitation.
   The destination data comprises, but is not limited to, at least one of: a place, structure, event, site, tourist site, college, university, business, target location, nearby location, additional location, location, movie theatre, specialty store, gas, restaurant, food, lodging, hotel, hostel, camp site, etc. Destination, a place, structure, event, site, address, school, tourist site, college, university, business, target location, nearby location, additional location, location, movie theatre, store, office, facility, professional space, professional location, professional address, professional practices, professional office, specialty store, gas, restaurant, food, lodging, hotel, hostel, camp site, and/or medical, dental, and/or health related practices, etc.

The locating information, desired radius limitation and type of input device can be the same or different as in the other embodiments.

The system and method of searching destinations can further comprise the steps of:
selecting one or more destinations from the relevant destinations generated;
generating information about the selected destinations; and
providing directions/information on available public transportation based on the selected destinations.

Additional destinations can be found, for example, by:
entering a second locating information, which can be the same or different from the first, and a desired second radius limitation, which can be the same or different from the first, into the input device;
generating a second batch of destinations relevant to the destination data and within the second radius limitation;
selecting destinations from the second batch of destinations; and
providing directions and/or information on available public transportation based on the first batch and the second batch of the selected destinations.

Additional nearby destinations can be found, for example, by:
requesting a repeat search of destinations within a radius limitation of one or more selected destinations;
generating repeat destinations within the radius limitation of one or more selected destinations;
selecting repeat destinations of interest; and
generating information about selected destinations of interest.

Additional nearby destinations can also be found, for example, by:
entering destination data for a nearby destination into an input device;
entering locating information for the original destination and a desired radius limitation into the input device; and
generating nearby destinations relevant to the destination data and within the radius limitation.

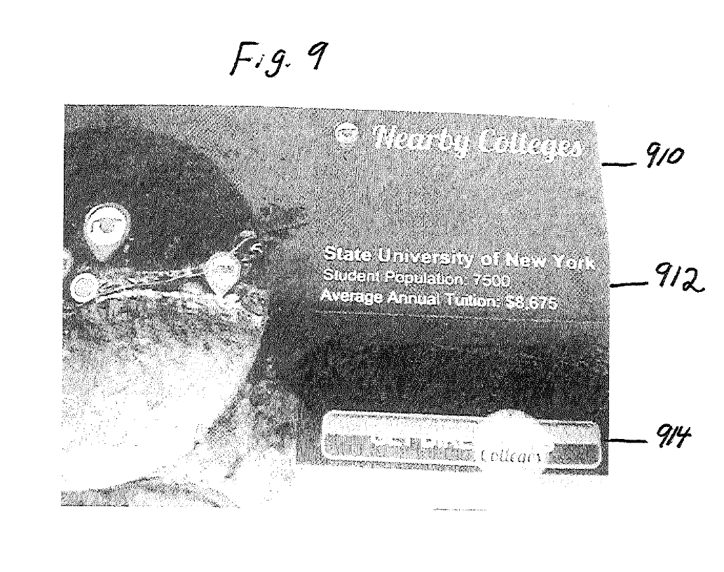

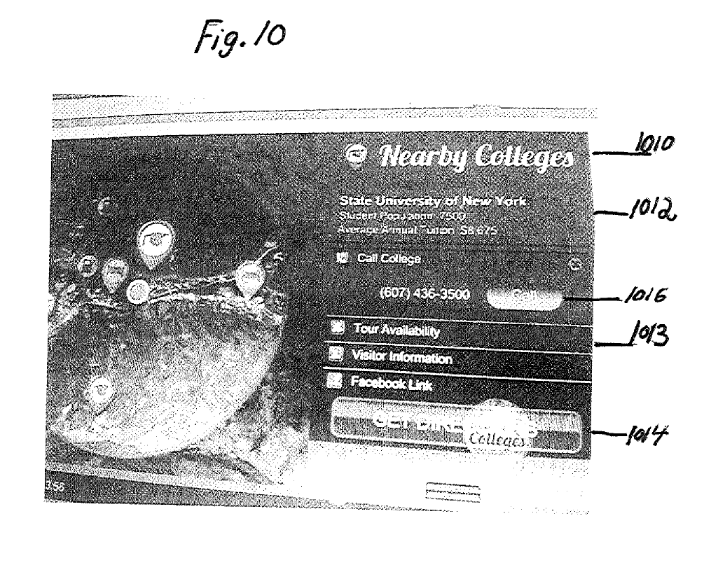

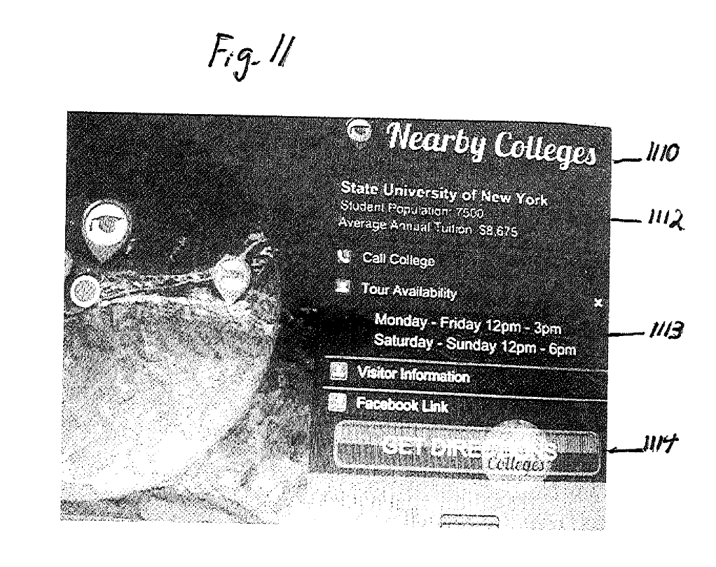

In an example of the invention, a user can search a specific city, zip code, or even a street address and all higher learning institutions within a user defined radius will pop up. Then the user can tap a school of interest and obtain information that at a glance can help decide if it's a school worth checking out. For example, a screen pops up with student population, average annual tuition, as shown in FIG. 9. It can also provide the user with links to optional information such as to call the college, obtain information on tour availability, make an appointment for an interview, visitor information, facebook link, etc., as shown in FIGS. 10 and 11.

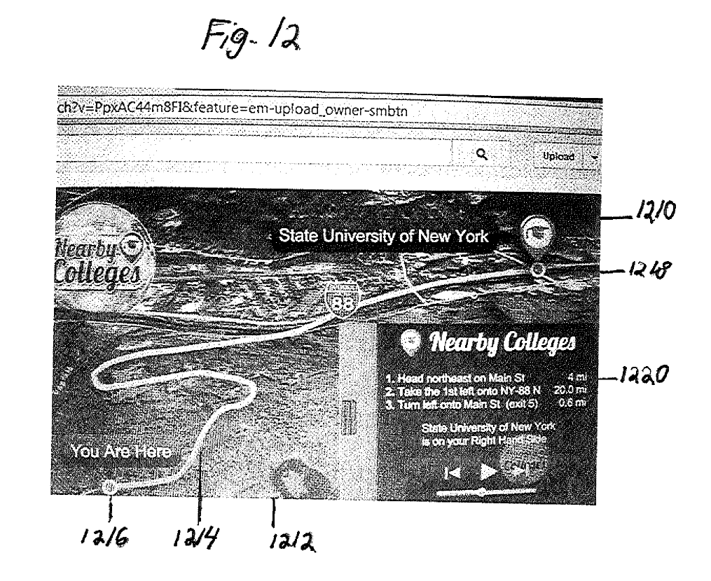

Also, directions can be accessed through an online map tool for quick planning of a driving route, as shown in FIG. 12, and information on food, lodging, gas, etc. can also be displayed. And, while on the road, the user can make quick and efficient changes in route when opportunities arise to see other schools and/or other stops and/or destinations, e.g., when there is more time available. It is easy to make adjustments to the route if desired.

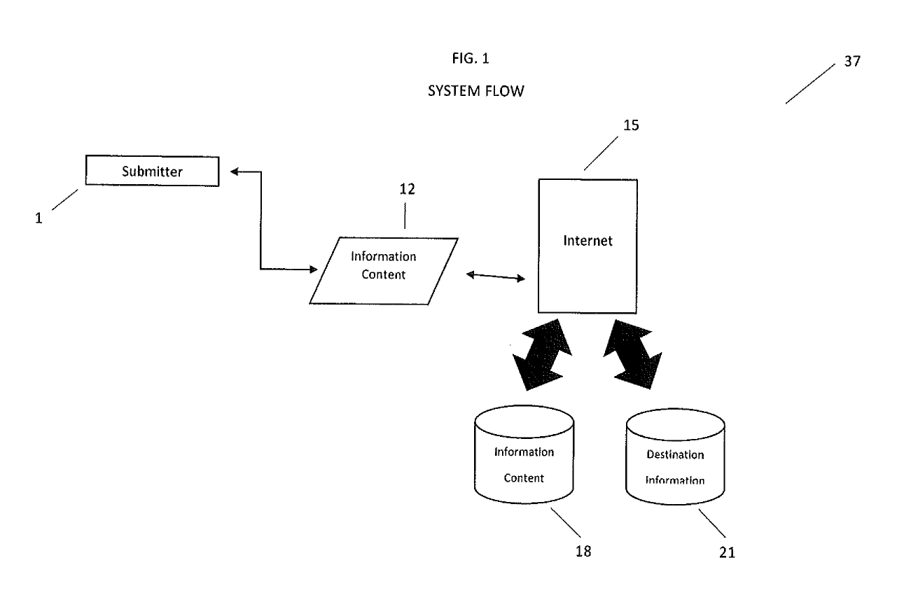

Some basic components of the system and method to search for or choose from destinations in accordance with the present invention are illustrated in FIG. 1. The flow is between the submitter/user 1 and the system 37 which includes an interface with the app 12 where the information/content is entered by the (user) submitter 1. The information/content then goes to the Internet 15 (world wide web, any virtual network, a WAN (wide-area network), and/or LAN (local-area network). The Internet 15 is connected to storage database 18, which holds the information/content which has been entered into the system through the input device. The Internet 15 is also connected to storage database 21, which holds the destination information.

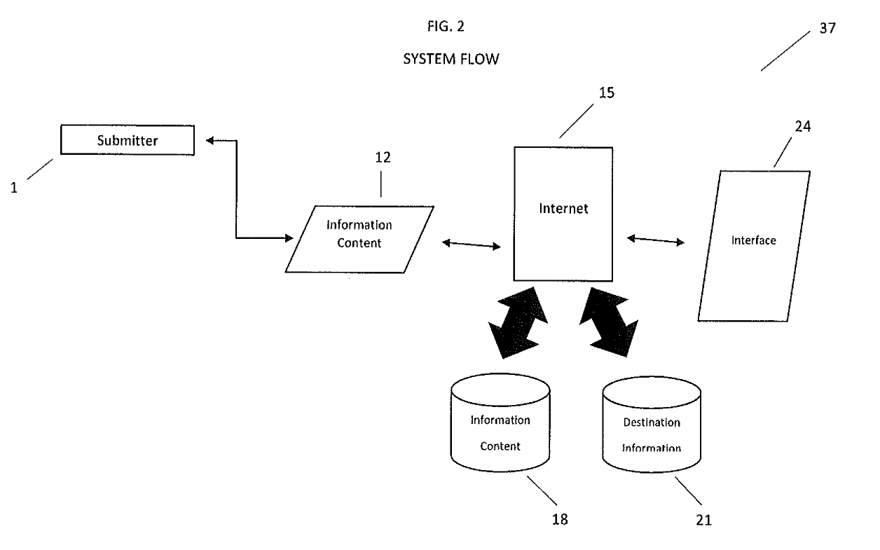

FIG. 2 depicts another embodiment of the invention showing system 37 in which additional steps can be added at interface 24.

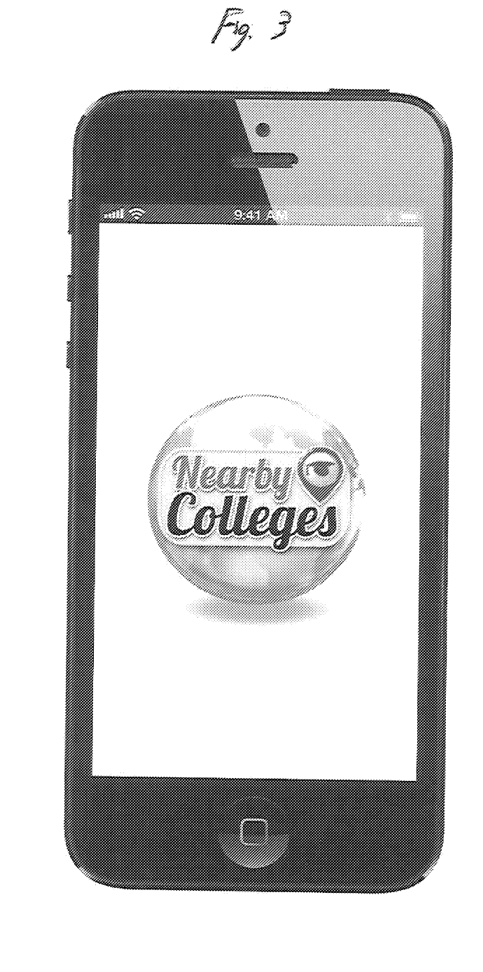

FIG. 3 depicts a smartphone with a Nearby Colleges icon. Submitter clicks the mobile application icon to startup/initiate mobile application.

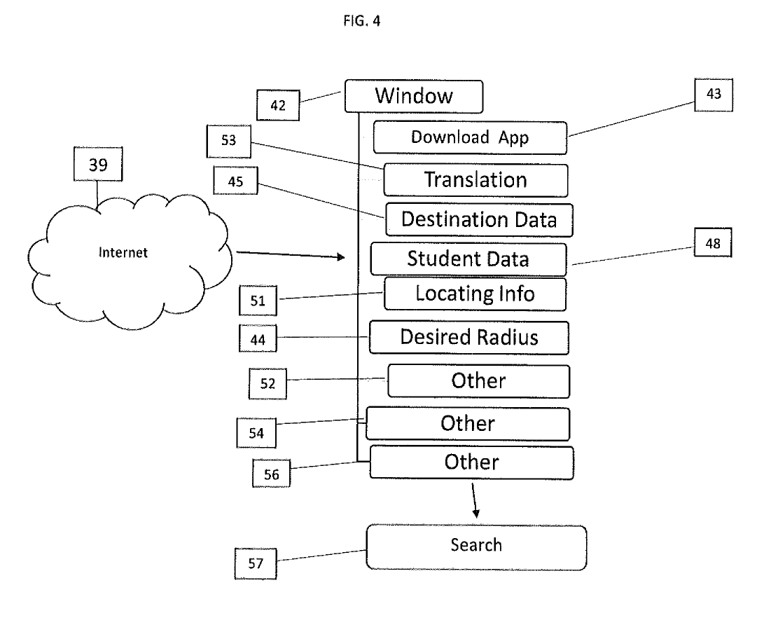

Referring to FIG. 4, an embodiment of a Message Submitter/user screen 1 is shown. In the embodiment of FIG. 4, a person who would like to submit a search request (“Submitter” or “User”) may optionally select to download a smart device application by clicking or selecting the application icon located on screen 1, and continue the process from the smart device or continue on screen 1 by first selecting the message window 42 from the designated website or application, optionally selecting from the language choices available 53 for the App, in whole or in part, (The current default is English), and then select and identify destination data 45, and/or student data 48, together with locating information 51 and desired radius 44. Other search specific information can be entered in, e.g., 52, 54, 56, etc. Lastly, the Submitter would click the graphic icon “Search” 57 to submit the search request.

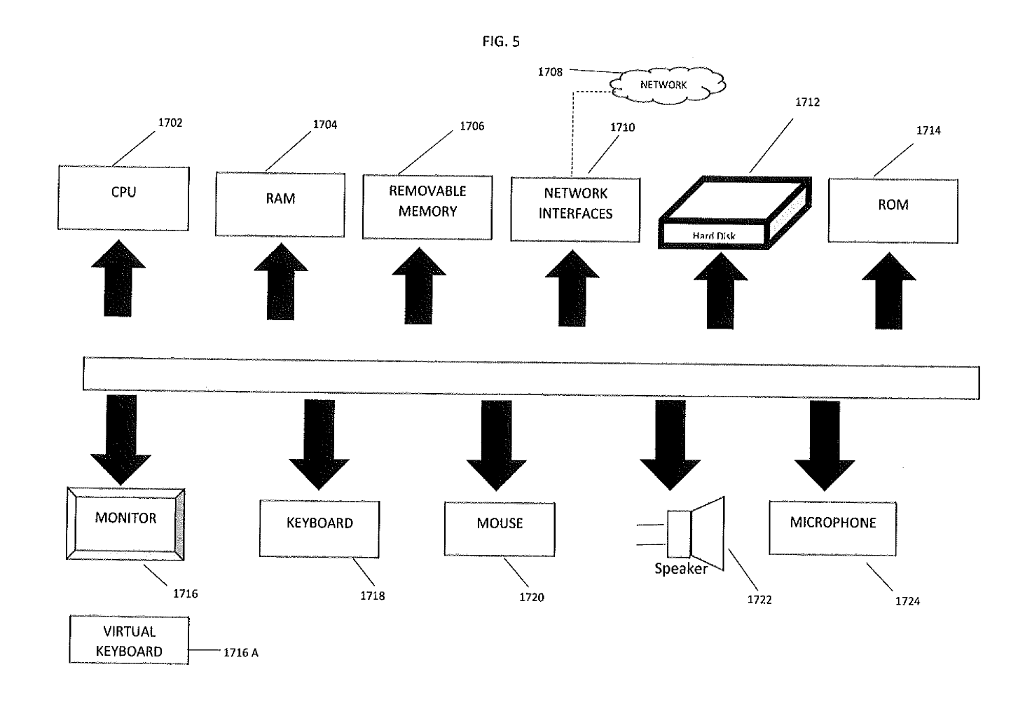

FIG. 5 depicts an illustrated block diagram of an exemplary information handling system. The information handling system comprises a bus that connects (either directly, or in combination with another bus) a Central Processing Unit (CPU, or processor) 1702 to RAM 1704, hard disc 1712, ROM 1714, and input/output devices. Additionally, the bus can have an interface for receiving removable memory 1706. Removable memory can include but is not limited to an optical disc, a memory card, a “boot” drive, etc. Additionally, the bus can connect the CPU 1702 to network interface(s) 1710. The network interface(s) 1710 can either physically or wirelessly connect the information handling system to one or more networks 1708, such as, but not limited to, the internet, WAN, and/or LAN, the Public System Telephone Network, a cellular telephone network, or a cellular data network.

Some input devices can include a mouse 1720, a keyboard 1718, and/or a microphone 1724. The output devices can include a screen 1716 and/or speaker(s) 1722. In certain embodiments, the screen 1716 can be heat or touch sensitive so as to project a virtual keyboard 1716A for receiving inputs, thus not requiring a keyboard 1718 or mouse 1720.

According to certain embodiments of the present invention, the invention incorporates a plurality of instructions that are executable by the CPU 1702, residing in any combination of RAM 1704, Removable Memory 1706, hard disc 1712, or ROM 1714. Additionally, the instructions can reside at a node on the network. It will be understood that storage of said instructions in the node, RAM 1704, Removable Memory 1706, hard disc 1712, or ROM 1714 changes the foregoing, chemically, electrically, and/or electromagnetically.

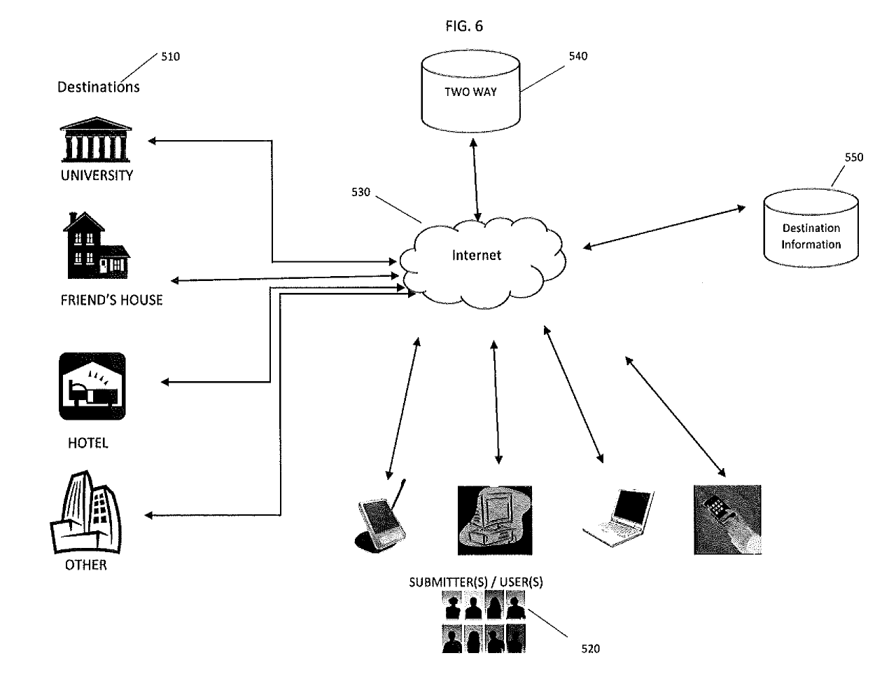

FIG. 6 depicts a typical system 37 enabling bi-directional connection via the cloud 530 (which can be comprised of one of more of the following: the internet, a virtual network, social network, world wide web, WAN, and/or LAN) of a collection of Submitter(s)/User(s) 520 using devices such as a smart phone, tablet, computer, laptop, etc. with a collection of Destinations 510 representing a variety of different places such as universities, friend's houses, hotels, and other places, and their bi-directional communication is enabled by a two-way communicator 540 for making reservations, appointments, etc. Information about the destinations is stored in storage database 550 (21), which holds the destination information.

By enabling bi-directional connection, the enterer (person entering information) can communicate directly with one or more of the generated C/Us or other destination using a communicator such as, but not limited to, 2-way text-to-cell communication, 2-way voice communication, 2-way Social Media communications, 2-way texting, 2-way phone, 2-way SMS, MMS, 2-way communication etc.

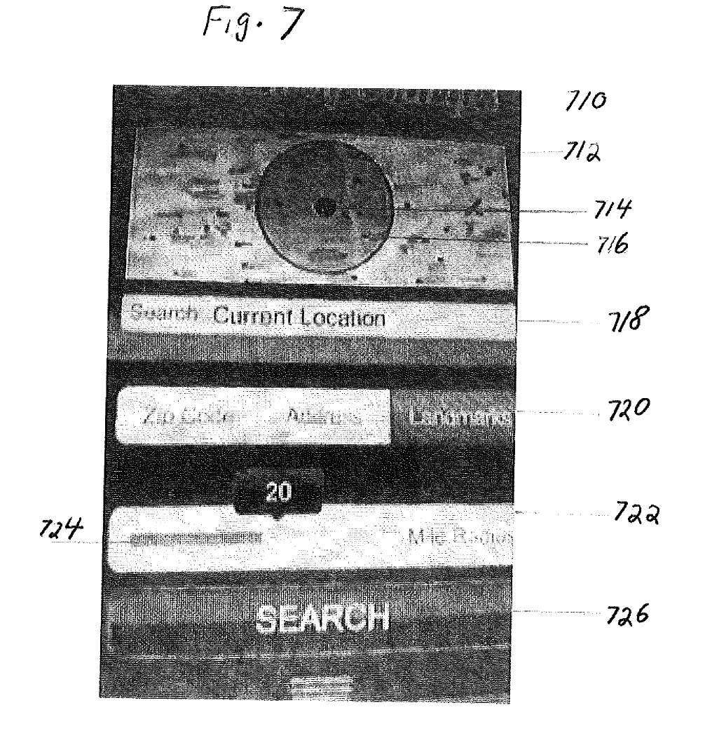

FIG. 7 shows an example of a search screen 710. It provides a map 712. In this example, the map 712 shows the point 714 of the chosen locating information at the center of an encircled area 716, which represents the radius searched. Also included is a search section 718 for the user to input the locating information, which in this example is “current location.” In this embodiment there is also a choice of three different types of locating information 720, i.e., zip code, address, or landmarks. In this example, the landmarks selection is highlighted showing that was chosen. Although three choices are shown in this example, more or fewer choices can be provided on the screen or in a drop-down menu. Also shown is a mile radius section 722 in which the user can select the radius to be searched. Mile radius section 722 in this embodiment in this example provides a sliding bar selection mechanism 724 which is set at 20 miles. When sliding bar selection mechanism 724 is moved to the left (for example, but not limited to, by dragging with a mouse, dragging a finger across the screen, dragging a stylus across the screen, using arrow keys, etc.) a radius of less than 20 miles can be chosen. When sliding bar selection mechanism 724 is moved to the right, a radius of more than 20 miles can be chosen.

The mile radius section 722 can also or instead be provided with units other than miles for measuring distance (by way of non-limiting example, feet, meters, kilometers, etc.). Also, the section for choosing the radius, which is mile radius section 722 in this example, does not have to employ a sliding bar mechanism. Any method of inputting a desired radius can be used, for example, but not limited to, by way of a drop-down menu with choices of potential radius values, using number keys, etc.

Also included in search screen 710 of FIG. 7 is a search selection section 726. In the present example, it is simply labeled “SEARCH”. Any method of selecting search selection section 726 can be used, for example, but not limited to, a mouse, a finger, a stylus, an enter key, arrow keys, etc.

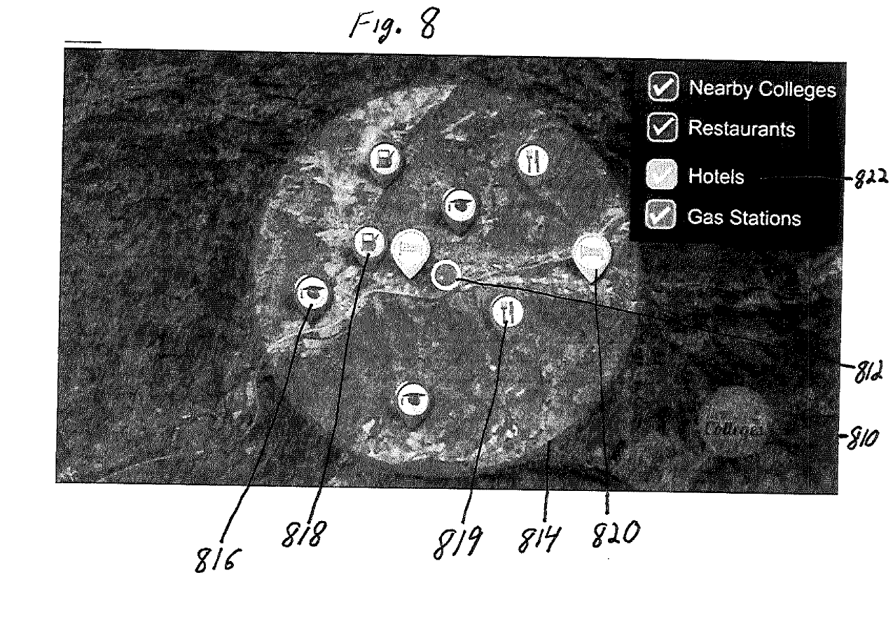

FIG. 8 is an example of a screen showing search results which have been generated. It includes a map 810, having a center point 812, and being enclosed in a circle 814 which delineates the radius searched from the center point 812. Also enclosed in circle 814 are C/Us 816, gas stations 818, restaurants 819, and hotels 820. A key 822 to the symbols for these other stops is included as well. Some symbols that might appear on the screen depicted in FIG. 8 are for example a knife and fork icon for restaurants, graduation hat for C/Us, a gas pump icon for gas stations, and/or a bed icon for hotels and/or lodging. The key 822 and/or the icons can have color distinctions. This type of search result screen, an example of which is shown in FIG. 8, could, in accordance with this invention, show only C/Us, or show only other stops (e.g., the gas stations, restaurants, and hotels shown in FIG. 8), and/or show other potential stops in addition to the other stops.

FIG. 9 is one example of a screen 910 which could pop up after selecting a particular C/U symbol in FIG. 8. In the example shown in FIG. 9, the screen 910 provides student data information in an information section 912. The student data information shown in this example includes the name of the school, its student population and its average annual tuition. The screen 910 also includes a direction selection section 914 labeled “GET DIRECTIONS”. Any method of selecting direction selection section 914 can be used, for example, but not limited to, a mouse, a finger, a stylus, an enter key, arrow keys, etc.

FIG. 10 is an example of a screen 1010, which pops up after selecting a particular C/U symbol in FIG. 8. In the example shown in FIG. 10, the screen 1010 provides student data information in an information section 1012 (similar to information section 912). Screen 1010 also provides additional student data information in another information section 1013. The additional student data information available in this example includes links to call the college, obtain information on tour availability, obtain visitor information, and facebook. Any method of selecting one or more of these links to additional student data information can be used, for example, but not limited to, a mouse, a finger, a stylus, an enter key, arrow keys, etc. In the example shown in FIG. 10, the “Call College” link has been selected, and a phone number is displayed, and a link 1016 to call the college using the device displaying the screen 1010 can be selected. Any method of selecting link 1016 to call the college can be used, for example, but not limited to, a mouse, a finger, a stylus, an enter key, arrow keys, etc.

The screen 1010 also includes a direction selection section 1014 labeled “GET DIRECTIONS”. Any method of selecting direction selection section 1014 can be used, for example, but not limited to, a mouse, a finger, a stylus, an enter key, arrow keys, etc.

FIG. 11 is another example of a screen 1110 which pops up after selecting a particular C/U symbol in FIG. 8. In the example shown in FIG. 11, the screen 1110 provides student data information in an information section 1112 (similar to information section 912 and 1012). Screen 1110 also provides additional student data information in another information section 1113. The additional student data information available in this example includes links to call the college, obtain information on tour availability, obtain visitor information, and a facebook link. Any method of selecting one or more of these links to additional student data information can be used, for example, but not limited to, a mouse, a finger, a stylus, an enter key, arrow keys, etc. In the example shown in FIG. 11, the “Tour Availability” link has been selected and the tour schedule is displayed.

The screen 1110 also includes a direction selection section 1114 labeled “GET DIRECTIONS”. Any method of selecting direction selection section 1114 can be used, for example, but not limited to, a mouse, a finger, a stylus, an enter key, arrow keys, etc.

FIG. 12 is an example of a screen 1210 which pops up after selecting a direction selection section, such as 1014 in FIG. 10 or 1114 in FIG. 11. It includes a map 1212 which shows the route 1214 to follow for the directions. The route 1214 is shown starting at a start point 1216 labeled “You Are Here” and ending at an end point 1218 which includes the icon for C/Us and is labeled “State University of New York”. Also, turn-by-turn directions are included in direction section 1220.

additionally:

The system and method can further comprising that the enterer/user can communicate directly with one or more of the generated C/Us with multiple communications that each can be more than 2-way communications.
The system and method can further comprises that the enterer/user can communicate directly with one or more of the generated C/Us using a communicator comprising at least one of the following: at least 2-way text-to-cell communication, at least 2-way voice communication, at least 2-way Social Media communications, at least 2-way texting, at least 2-way phone, at least 2-way SMS and/or MMS, and/or at least 2-way communication.
The invention can be a non-transitory storage device storing a plurality of instructions, to conduct a search, and/or visit of colleges and/or universities (“C/Us”) wherein said non-transitory storage device comprises a plurality of instructions for:
entering student data into an input device;
entering locating information and a desired radius limitation into the input device; and
generating C/Us relevant to the student data and within the radius limitation.
The non-transitory storage device can further have the instructions further comprise at least one of the following steps of:
a) selecting one or more C/Us from the relevant C/Us generated, generating information about the selected C/Us, and/or providing an itinerary of selected C/Us or planned route or journey; or
b) entering a second locating information, which can be the same or different from the first, and a second desired radius limitation, which can be the same or different from the first, into the input device, generating a second batch of C/Us relevant to the student data and within the second radius limitation, selecting C/Us from the second batch of C/Us, and providing an itinerary based on the first batch and the second batch of the selected C/Us or planned route or journey; and/or
c) requesting a repeat search of C/Us within a radius limitation of one or more selected C/Us, generating repeat C/Us within the radius limitation of one or more selected C/Us, selecting repeat C/Us of interest, generating information about selected C/Us of interest;
   and/or
d) entering other stops or destination data into the input device;
   and/or
e) entering the C/Us or other locating information and/or a desired radius limitation into the input device; and/or
f) generating other stops relevant to the other stops data and within the radius limitation if applicable;
   and/or
g) further comprising a software element that can utilize a map API (Application Programming Interface); and/or
h) selecting one or more C/Us from the relevant C/Us generated and saving the selected C/Us as a group; and/or
i) entering student data for another group, which is the same or different from the student data which has already been entered, into an input device, entering locating information for that other group, which is the same or different from the locating information which has already been entered, and/or a desired radius limitation into a input device, generating C/Us relevant to the student data for that other group and/or within the radius limitation, selecting one or more C/Us from the generated C/Us relevant to the student data for that other group and saving the selected C/Us as another group, repeating steps a through d as often as desired; and entering further student data into the input device to generate a combined list of C/Us from all the groups and relevant to the further student data entered; and/or
j) entering into the input device another set of student data, which is the same or different from the student data which has already been entered, and generating C/Us relevant to the other set of student data from the group of C/Us which has already been selected; and/or
k) further comprises that the enterer can communicate directly with one or more of the generated C/Us using a communicator comprising at least one of the following: at least a 2-way text-to-cell communication, at least a 2-way voice communication, at least a 2-way Social Media communications, at least a 2-way texting, at least a 2-way phone, at least a 2-way SMS and/or MMS, and/or at least a 2-way communication; and/or
L) providing information about food, gas and/or lodging within a selected radius of the selected C/Us.

While the instant invention has been shown and described in accordance with preferred and practical embodiments thereof, it is recognized that departures from the instant disclosure are contemplated within the spirit and scope of the present invention. Therefore, the true scope of the invention should not be limited since other modifications will become apparent to those skilled in the art upon a study of the claims, drawings, descriptions, explanations, and specifications herein. It is understood that various changes and modifications can be made within the spirit and scope of the present invention.

What is claimed is:

1. A system and a method to conduct a search, and/or visit of colleges and/or universities (“C/Us”) comprising the steps of:
entering student data into an input device;
entering locating information and a desired radius limitation into the input device; and
generating C/Us relevant to the student data and within the radius limitation.

2. The system and method of claim 1, wherein student data comprises at least one of student qualifications and/or student choices.

3. The system and method of claim 2, wherein student qualifications comprise of at least one of standardized test scores, SAT scores, ACT scores, GPA scores, school attended, school attending, year of graduation, public or private school, years of attendance, high school attending, high school attended, type of education, degree(s), grade(s), course(s), curriculum, school rating, class rating, class ranking, student rating, and/or student ranking.

4. The system and method of claim 2, wherein student choices comprise of at least one of curriculum, degrees offered, school requirements, public or private, tuition, additional school costs, extracurricular activities, school organizations, student organizations, size of school, type of school, housing, school statistics, school information, school data, school criteria, school history, faculty, faculty information, school achievements or honors, school reputation, school area information, distance coordinates, and/or travel considerations.

5. The system and method of claim 1, wherein the locating information comprises of at least one of longitude, latitude, location coordinates, a city, zip code, street address, street name, state, nearby location, county, village, town, landmark, destination, destination address in part or in whole, college, university, school, school name, phone number in part or in whole, email, web address, social media address, and/or Skype name.

6. The system and method of claim 1, wherein the locating information is used as the center point or starting point from which to generate relevant C/Us within the desired radius limitation.

7. The system and method of claim 1, wherein the desired radius limitation is 5 miles, 10 miles, 15 miles, 20 miles, 30 miles, 40 miles, 50 miles, 75 miles, or any specified number of miles (or other unit of measurement).

8. The system and method of claim 1, wherein the desired radius limitation is any specified number of miles (or other unit of measurement), for example from 0-250, and can be selected by a sliding option with increments including plus or minus.

9. The system and method of claim 1, wherein the input device is a tablet, smart phone, phone, mobile device, smart device, computer, microphone, fax, facsimile, electronic device, hand held device, iphone, or ipad, mobile phone, touch-screen computing device, portable media player, smart pad, smart device, computer, micro device, portable device, powered device, technical device, electronic component device, ios device, optical device, optical reader, the means by which a user can communicate with the system and method of the invention, touch pad, information or data input communication device, key board, portable device, virtual device, Bluetooth, and/or voice prompt.

10. The system and method of claim 1, further comprising the steps of:
selecting one or more C/Us from the relevant C/Us generated;
generating information about the selected C/Us; and/or
providing an itinerary of selected C/Us or planned route or journey.

11. The system and method of claim 10, further comprising the steps of:
entering a second locating information, which can be the same or different from the first, and a second desired radius limitation, which can be the same or different from the first, into the input device;
generating a second batch of C/Us relevant to the student data and within the second radius limitation;
selecting C/Us from the second batch of C/Us; and
providing an itinerary based on the first batch and the second batch of the selected C/Us or planned route or journey.

12. The system and method of claim 10, further comprising:
requesting a repeat search of C/Us within a radius limitation of one or more selected C/Us;
generating repeat C/Us within the radius limitation of one or more selected C/Us;
selecting repeat C/Us of interest;
generating information about selected C/Us of interest.

13. The system and method of claim 12, wherein the information generated about the selected C/Us comprises at least one of student population, average annual tuition, tuition, tour availability, admissions information, admissions appointments or availability, visiting information, tour information, and/or information sessions.

14. The system and method of claim 12, wherein the information generated about the selected C/Us comprises at least one of a link to communicate with, call the C/Us, link to the C/Us' website, link to make an online appointment for an interview, and/or link to the C/Us' facebook page or other social media.

15. The system and method of claim 1, further comprising:
entering other stops or destination data into the input device; and/or
entering the C/Us or other locating information and/or a desired radius limitation into the input device; and
generating other stops relevant to the other stops data and within the radius limitation if applicable.

16. The system and method of claim 1,
further comprising a software element that can utilize a map API (Application Programming Interface).

17. The system and method of claim 1, further comprising the step of:
selecting one or more C/Us from the relevant C/Us generated and saving the selected C/Us as a group.

18. The system and method of claim 17, further comprising the steps of:
a) entering student data for another group, which is the same or different from the student data which has already been entered, into an input device;
b) entering locating information for that other group, which is the same or different from the locating information which has already been entered, and/or a desired radius limitation into a input device;
c) generating C/Us relevant to the student data for that other group and/or within the radius limitation;
d) selecting one or more C/Us from the generated C/Us relevant to the student data for that other group and saving the selected C/Us as another group;
e) repeating steps a through d as often as desired; and
entering further student data into the input device to generate a combined list of C/Us from all the groups and relevant to the further student data entered.

19. The system and method of claim 17, further comprising the steps of:
entering into the input device another set of student data, which is the same or different from the student data which has already been entered;
and generating C/Us relevant to the other set of student data from the group of C/Us which has already been selected.

20. The system and method of claim 1, further comprises that the enterer can communicate directly with one or more of the generated C/Us using a communicator comprising at least one of the following: 2-way text-to-cell communication, 2-way voice communication, 2-way Social Media communications, 2-way texting, 2-way phone, 2-way SMS and/or MMS, and/or 2-way communication.

21. The system and method of claim 1, further comprising generating a map showing the relevant C/Us, a graph and/or table; and selecting from list or further qualifying.

22. The system and method of claim 1, further comprising sorting the generated C/Us by one or more of distance, price, schools, divisions, majors, curriculums, clubs, sports, activities, organizations, student information, school information, student qualifications, school qualifications, honors, awards, financial add, scholarships, student employment information, student population, average annual tuition, tour availability, information sessions, and/or size.

23. The system and method of claim 1, further comprising:
providing information about food, gas and/or lodging within a selected radius of the selected C/Us.

24. A system and a method to conduct a search visit of colleges and/or universities (“C/Us”) comprising the steps of:
sending locating information and a desired radius limitation to an input device;
generating C/Us within the radius limitation;
selecting C/Us of interest; and
generating information about selected C/Us.

25. The system and method of claim 24, wherein all C/Us within the radius limitation are generated.

26. The system and method of claim 24, wherein the information generated about the selected C/Us comprises at least one of student population, average annual tuition, tour availability, information sessions, distance, price, schools, divisions, majors, curriculums, clubs, sports, activities, organizations, student information, school information, student qualifications, school qualifications, honors, awards, financial add, scholarships, student employment information, and/or size.

27. The system and method of claim 24, wherein the information generated about the selected C/Us comprises at least one of a link to call the C/Us, link to the C/Us' website, a link to make an online appointment for an interview, and/or link to the C/Us' facebook page or other social media.

28. The system and method of claim 24, wherein the locating information is at least one of longitude, latitude, location coordinates, a city, zip code, street address, street name, state, nearby location, county, village, town, landmark, destination, college, university, school name, phone number in part or in whole, email, web address, social media address, and/or Skype name, longitude, latitude, location coordinates, city, zip code, street address, street name, state, nearby location, county, village, town, landmark, destination, college, university, school name, phone number in part or in whole, email, web address, social media address, Skype name, Destinations, a place, structure, event, site, address, school, tourist site, college, university, business, desired location, target location, nearby location, additional location, location, movie theatre, store, office, facility, professional space, professional location, professional office, professional practices, professional address, specialty store, gas, restaurant, food, lodging, hotel, hostel, camp site, and/or medical, dental, and/or health related practices, etc.

29. The system and method of claim 24, wherein the desired radius limitation is 5 miles, 10 miles, 15 miles, 20 miles, 30 miles, 40 miles, 50 miles, 75 miles, or any specified number of miles (or other unit of measurement).

30. The system and method of claim 24, further comprising:
providing information about food, gas and/or lodging within a selected radius of the selected C/Us.

31. The system and method of claim 24, further comprising:
requesting a repeat search of C/Us within a radius limitation of one or more selected C/Us;
generating repeat C/Us within the radius limitation of one or more selected C/Us;
selecting repeat C/Us of interest; and
inputting and/or generating information about selected C/Us of interest.

32. The system and method of claim 24, wherein the input device is a tablet, smart phone, phone, mobile device, smart device, computer, microphone, fax, facsimile, electronic device, iphone, ipad, tablets, smart phones, phone, mobile device, smart device, computers, voice prompt, microphone, fax, facsimile, electronic device, iphone, ipad, Bluetooth device, hand held device, iphone, ipad, mobile phone, touch-screen computing device, portable media player, smart pad, micro device, portable device, powered device, technical device, electronic component device, ios device, optical device, optical reader, global positioning system (GPS).

33. The system and method of claim 24, further comprising:
entering other stops data into the input device;
entering the C/Us or other locating information and a desired radius limitation into the input device; and
generating other stops relevant to the other stops data and within the radius limitation.

34. A system and method to conduct a search of destinations comprising the steps of:
entering destination data into an input device;
entering locating information and a desired radius limitation into the input device; and
generating destinations relevant to the destination data and within a radius limitation.

35. The system and method of claim 34, wherein destination data comprises at least one of type of destination, name of destination, and/or category of destination, or a place, structure, event, site, address, school, tourist site, college, university, business, target location, desired location, nearby location, additional location, location, movie theatre, store, office, facility, professional space, professional location, professional address, professional office, specialty store, gas, restaurant, food, lodging, hotel, hostel, camp site, and/or medical, dental, and/or health related practices, geographic coordinate(s), geolocation, longitude and/or latitude, measurements, address in part or in whole, a place, structure, event, site, address, school, tourist site, college, university, business, target location, nearby location, additional location, location, movie theatre, store, office, facility, professional space, professional location, professional address, professional practices, professional office, specialty store, gas, restaurant, food, lodging, hotel, hostel, camp site, and/or medical, dental, and/or health related practices.

36. The system and method of claim 34, wherein the locating information is at least one of longitude, latitude, location coordinates, a city, zip code, street address, street name, state, nearby location, county, village, town, landmark, destination, college, university, school name, phone number in part or in whole, email, web address, social media address, and/or Skype name.

37. The system and method of claim 34, wherein the desired radius limitation is 5 miles, 10 miles, 15 miles, 20 miles, 30 miles, 40 miles, 50 miles, 75 miles, or any specified number of miles (or any other unit of measure).

38. The system and method of claim 34, further comprising the steps of:
selecting one or more destinations from the relevant destinations generated;
generating information about the selected destinations; and
providing directions/information on available public or other transportation based on the selected destinations.

39. The system and method of claim 38, further comprising the steps of:
entering a second locating information, which can be the same or different from the first, and a desired second radius limitation, which can be the same or different from the first, into the input device;
generating a second batch of destinations relevant to the destination data and within the second radius limitation;
selecting destinations from the second batch of destinations; and
providing directions/information on available public transportation based on the first batch and the second batch of the selected destinations.

40. The system and method of claim 38, further comprising:
requesting a repeat search of destinations within a radius limitation of one or more selected destinations;
generating repeat destinations within the radius limitation of one or more selected destinations;
selecting repeat destinations of interest; and
generating information about selected destinations of interest.

41. The system and method of claim 20, further comprising that the enterer/user can communicate directly with one or more of the generated C/Us with multiple communications that each can be more than 2-way communications.

42. The system and method of claim 1, further comprises that the enterer/user can communicate directly with one or more of the generated C/Us using a communicator comprising at least one of the following: at least 2-way text-to-cell communication, at least 2-way voice communication, at least 2-way Social Media communications, at least 2-way texting, at least 2-way phone, at least 2-way SMS and/or MMS, and/or at least 2-way communication.

43. A non-transitory storage device storing a plurality of instructions, to conduct a search, and/or visit of colleges and/or universities (“C/Us”) wherein said non-transitory storage device comprises a plurality of instructions for:
entering student data into an input device;
entering locating information and a desired radius limitation into the input device; and
generating C/Us relevant to the student data and within the radius limitation.

44. The non-transitory storage device of claim 43, wherein the instructions further comprise at least one of the following steps of:
a) selecting one or more C/Us from the relevant C/Us generated, generating information about the selected C/Us, and/or providing an itinerary of selected C/Us or planned route or journey; or
b) entering a second locating information, which can be the same or different from the first, and a second desired radius limitation, which can be the same or different from the first, into the input device, generating a second batch of C/Us relevant to the student data and within the second radius limitation, selecting C/Us from the second batch of C/Us, and providing an itinerary based on the first batch and the second batch of the selected C/Us or planned route or journey; and/or
c) requesting a repeat search of C/Us within a radius limitation of one or more selected C/Us, generating repeat C/Us within the radius limitation of one or more selected C/Us, selecting repeat C/Us of interest, generating information about selected C/Us of interest;
and/or
d) entering other stops or destination data into the input device;
and/or
e) entering the C/Us or other locating information and/or a desired radius limitation into the input device; and/or
f) generating other stops relevant to the other stops data and within the radius limitation if applicable;
and/or
g) further comprising a software element that can utilize a map API (Application Programming Interface); and/or
h) selecting one or more C/Us from the relevant C/Us generated and saving the selected C/Us as a group; and/or
i) entering student data for another group, which is the same or different from the student data which has already been entered, into an input device, entering locating information for that other group, which is the same or different from the locating information which has already been entered, and/or a desired radius limitation into a input device, generating C/Us relevant to the student data for that other group and/or within the radius limitation, selecting one or more C/Us from the generated C/Us relevant to the student data for that other group and saving the selected C/Us as another group, repeating steps a through d as often as desired; and entering further student data into the input device to generate a combined list of C/Us from all the groups and relevant to the further student data entered; and/or
j) entering into the input device another set of student data, which is the same or different from the student data which has already been entered, and generating C/Us relevant to the other set of student data from the group of C/Us which has already been selected; and/or
k) further comprises that the enterer can communicate directly with one or more of the generated C/Us using a communicator comprising at least one of the following: at least a 2-way text-to-cell communication, at least a 2-way voice communication, at least a 2-way Social Media communications, at least a 2-way texting, at least a 2-way phone, at least a 2-way SMS and/or MMS, and/or at least a 2-way communication; and/or
L) providing information about food, gas and/or lodging within a selected radius of the selected C/Us.
